(19) United States
(12) Patent Application Publication
(10) Pub. No.: US 2003/0236985 A1
(43) Pub. Date: Dec. 25, 2003

(54) Transaction security in electronic commerce

(75) Inventor: Anna-Leena Ruuth, Espoo (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/442,321

(22) Filed: May 20, 2003

Related U.S. Application Data
(63) Continuation of application No. PCT/EP01/00985, filed on Jan. 31, 2001.
(63) Continuation of application No. PCT/EP01/00983, filed on Jan. 31, 2001.
(63) Continuation of application No. PCT/EP01/00984, filed on Jan. 31, 2001.

(30) Foreign Application Priority Data
Nov. 24, 2000 (GB) 0028729.2
Nov. 24, 2000 (GB) 0028730.0
Nov. 24, 2000 (GB) 0028731.8

(51) Int. Cl. H04L 9/00

(52) U.S. Cl. 713/173; 713/201; 713/153

(57) ABSTRACT

A device, system and method are described for parsing and propagating end user identity received from a terminal (1) involved in a wireless session to an application in a gateway server (13). The PLMN (7) of which terminal (1) forms part provides access to external networks including a PSTN (9). In addition to conventional telephone operations, the terminal (1) provides its user with access to the internet (11) via the gateway server (13). The gateway server (13) may be operated by a service provider or perhaps a particular organisation such as a bank which for security reasons wishes to keep control of the gateway server (13). Software through which the transactions are carried out is provided by various so-called back-end applications resident on an applications server (17). A trust server (30) is provided which is connectable to the gateway server (13) controlling access to the application server (17).

### CROSS-REFERENCE TO RELATED APPLICATIONS

This application is a continuation of International Patent Application No. PCT/EP01/00985 (published as WO02/42889), which was filed on Jan. 31, 2001 and which claims priority from GB 0028729.2, dated Nov. 24, 2000. This application also is a continuation of International Patent Application No. PCT/EP01/00983 (published as WO02/43345), which was filed on Jan. 31, 2001 and which claims priority from GB 0028730.0, dated Nov. 24, 2000. This application also is a continuation of International Patent Application No. PCT/EP01/00984 (published as WO02/43346), which was filed on Jan. 31, 2001 and which claims priority from GB 0028731.8, dated Nov. 24, 2000. The contents of each of these International patent applications and the contents of each of the priority applications is incorporated herein by reference.

### FIELD OF THE INVENTION

The present invention relates to transaction security, particularly, although not exclusively, in electronic commerce.

### BACKGROUND OF THE INVENTION

The arrival of electronic commerce has caused many providers of products and in particular services to consider adopting electronic commerce as a new sales channel. However the security implications both for the provider and the purchaser are significant particularly when it realized that some of the traditional safeguards when carrying out a transaction, namely the physical presence of the parties and/or the means of payment have been removed.

Whereas, in the past it was at least possible to compare a signature on a credit card or check with a specimen or even to present a credit card to a card reader for verification, this is clearly no longer an option when transactions are being carried out remotely, as is the case with those transaction taking place over the Internet. Furthermore, it has been recognized that the different priorities exist for the purchaser and vendor of products/services in Internet based transactions.

From the purchaser's perspective, she may be presented with a large number of potential vendors most if not all could be previously unknown to her. When attempting to transact with her selected vendor she will want to be confident that she can trust the vendor. However, unlike a conventional face to face transaction she cannot make any form of assessment of the trust worthiness of the vendor based on the condition of the vendors premises, his staff, other customers and the like.

Attempts have been made from each perspective to overcome these problems. Thus, in the case of the purchaser there has been quite universal adoption of a session-based protocol namely the Secure Sockets Layer Protocol. This protocol in its overwhelmingly most common guise permits a session to be established in which the identity of a server possibly under the control of the vendor is made available in the form of a certificate generated in accordance with the principles of the Public Key Infrastructure (PKI). The purchaser is thus able to assure herself that the server operator has a certificate in which she is prepared to place her trust, the certificate therefore acts as a form of guarantee of the good faith of the server owner.

A consequence of the adoption of a session encryption based on the PKI is that the number of enquires made of Certification Authorities (CA) will rise as the number of certificates increases. This will place a huge load on the validation effort.

Similarly, the vendor has the difficulty of receiving many requests from people unknown to him all of whom purport to have legitimate means for making payment. Thus, in the case of the vendor, the approach adopted to resolve the problem has depended largely on the nature of the business relationship with the purchaser. Hence, where a pre-existing relationship is in place, perhaps the purchaser is a customer of a bank with which she wishes to carry out a transaction, then one approach has been to provide the purchaser with passwords in the form of shared secrets. Accordingly, such passwords need to be supplied before a transaction takes place. The provision of passwords before the transaction takes place is clearly not feasible where the transaction is between parties having no pre-existing or continuing relationship. In such case, the vendor may be forced simply to carry out off-line checks on the validity of credit cards and the like.

Even though attempts have been made from each perspective to overcome these problems, there exists the fundamental difficulty of migrating existing applications to this new channel. In addition, there continues to exist a class of provider who lacks the resources and/or expertise to carry out such a migration. In some cases the nature of existing applications are such that they cannot be utilized in this form of commerce even with the security techniques presently in use.

### SUMMARY OF THE INVENTION

According to an aspect of the invention, there is provided a trust server connectable to a gateway server controlling access to a remote server, the trust server comprising a validator operable to validate data received from said gateway server and to store said data in data storage such that said data is retrievable by said gateway server, wherein the validator is operable to identify time-critical and non time-critical validations of said data and to deliver status information relating to each said validation to said gateway appropriately.

By delaying part of the validation until after a secure session has been established it is possible to provide the user with feedback at the application level on whether or not the session has been established successful.

Previously, a user would simply note that the session establishment had failed without any indication as to the cause thereby reducing the confidence of the user in the overall system. By restricting the retrieval to part of the data, there is a resulting reduction on the resource-demanding requirement of validating certificates. As a result of this utilization of Certificate Revocation Lists (CRLs) the purchaser and provider may both be assured that the transaction they intend to carry through is between parties known or at least trusted by each other.

Also according to the invention, there is provided a transaction security device for connection to a network including at least one terminal, the device comprising a server operable to validate data provided by a terminal over said connection in order to establish a secure session, wherein said server is operable to carry out time-critical and non time-critical validations of said data and to deliver status information relating to each said validation to said device appropriately.

Additionally according to the invention, there is provided a transaction security system comprising a gateway server connected to a network including at least one terminal and a trust server connected to said gateway server, the trust server being operable to validate data received from said gateway server as provided by a terminal over said connection in order to establish a secure session between said terminal and gateway server, wherein the validator is operable to carry out time-critical and non time-critical validations of said data and to deliver status information relating to each said validation to said gateway server appropriately.

According to a yet further aspect of the invention, there is provided a transaction security method for a server connected to a network, the method comprising receiving a request to establish a-secure session over a network connection and enabling said secure session in response to successful validation of data accompanying said request and following the establishment of said session, selectively performing a further validation of said data such that said session is terminated following an unsuccessful such further validation.

According to another aspect of the invention, there is provided a transaction security device for connection to a network including at least one terminal, the device comprising a server operable to validate data provided by a terminal over said connection in order to establish a secure session and a controller providing access to at least one application over said secure session, the device being operable to respond to a request from said terminal to access an application by obtaining at least part of said previously validated data from said server and forwarding said data to said controller, wherein access to an application is determined by said controller in accordance with said data.

Advantageously, this merging of the security approach with a mechanism for selection of an application results in increased confidence for both parties to a transaction. The purchaser is no longer reliant merely on the assumption that the vendor is the party behind the session and the vendor has greater confidence in the identity of the purchaser and furthermore in the case of the pre-existing customer relationship, is able to dispense with the overheads and complexity involved in administering a separate security solution.

According to a further aspect of the invention, there is provided a transaction security system comprising a server connected to a network including at least one terminal, the server being operable to validate data provided by a terminal over said connection in order to establish a secure session therewith, said server being further operable to respond to a request from said terminal for access to an application by providing at least part of said validated data to a controller, such that a determination on whether to permit access by said terminal is made by said controller in response to said validated data.

Advantageously, the validation of the data by the server removes the requirement for the extensive data-entry required by application level security.

This has the benefit of both reducing the amount of data-entry required from the user cutting down on log-in time and the possibility of error. It also removes a perceived barrier to the adoption of electronic commerce, namely that of complexity namely, if the user believes that too many steps are required to access a service, she will not use it.

According to a still further aspect of the invention, there is provided a transaction security method for a server connected to a network, the method comprising the server acting on a request to establish a secure session over a network connection by validating data received in said request and, following establishment of said session, determining whether to allow a request to access an application by reference to at least part of said previously validated data.

It will be recognized that by delegating the responsibility for application selection to the system, the need for user intervention and hence complication and potential for error is removed. Preferably, the data on which the application is selected will include details of URL and privileges which may pertain to a particular user or class of user as identified by the relevant certificate. The fact that this data may easily be modified enhances the value of the gateway to application owners.

According to a yet further aspect of the invention, there is provided a trust server connectable to a gateway server controlling access to a remote server, the trust server comprising a validator, and data storage, wherein the validator is responsive to a first request from said gateway server to deliver status information relating to data received by said gateway server and to store said data in said storage such that said data is retrievable by said gateway server, said gateway server being operable to determine from said retrieved data and status information whether to allow a request to access said remote server.

Attempts have been made from each perspective to overcome some of the above-stated problems. Thus, in the case of the purchaser there has been quite universal adoption of a session-based protocol namely the Secure Sockets Layer Protocol. This protocol in its overwhelmingly most common guise permits a session to be established in which the identity of a server possibly under the control of the vendor is made available in the form of a certificate generated in accordance with the principles of the Public Key Infrastructure (PKI). The purchaser is thus able to assure herself that the server operator has a certificate in which she is prepared to place her trust, the certificate therefore acts as a form of guarantee of the good faith of the server owner.

In the case of the vendor, the approach adopted to resolve the problem has depended largely on the nature of the business relationship with the purchaser. Thus, where a pre-existing relation is in place, perhaps the purchaser is a customer of a bank with which she wishes to carry out a transaction, then one approach has been to provide the purchaser with passwords in the form of shared secrets. Hence, such passwords need to be supplied before a transaction takes place. The provision of passwords before the transaction takes place is clearly not feasible where the transaction is between parties having no pre-existing or continuing relationship. In such a case, the vendor may be forced simply to carry out off-line checks on the validity of credit cards and the like.

According to another aspect of the present invention there is provided a transaction security device for connection to a network including at least one terminal, the device comprising a server operable to validate data provided by a terminal over said connection in order to establish a secure session, the device being operable to respond to a request from said terminal to access an application by obtaining said previously validated data from said server and forwarding said data to said application along with said request.

Advantageously, this merging of the security approach results in increased confidence for both parties to a transaction. The purchaser is no longer reliant merely on the assumption that the vendor is the party behind the session and the vendor has greater confidence in the identity of the purchaser and furthermore in the case of the pre-existing customer relationship, is able to dispense with the overheads and complexity involved in administering a separate security solution.

According to a further aspect of the invention, there is provided a trust server connectable to a gateway server controlling access to a remote server, the trust server comprising a validator and data storage, wherein the validator is responsive to a first request from said gateway server to deliver status information relating to data received by said gateway server and to store said data in said storage such that said data is retrievable by said gateway server for inclusion in a request to said remote server.

Advantageously, the validation of the data by the server removes the requirement for the extensive data-entry required by application level security. This has the benefit of both reducing the amount of data-entry required from the user and also cutting down on log-in time and the possibility of error. It also removes a perceived barrier to the adoption of electronic commerce, namely that of complexity; if the user believes that too many steps are required to access a service, she will not use it.

According to a still further aspect of the invention, there is provided a transaction security system comprising a server connected to a network including at least one terminal, the server being operable to validate data provided by a terminal over said connection in order to establish a secure session therewith, said server being further operable to respond to a request from said terminal for access to an application by providing said validated data to said application, such that a determination on whether to permit access by said terminal is made by said application in response to said validated data.

Whilst according to a yet further aspect of the invention, there is provided a transaction security method for a server connected to a network, the method comprising acting on a request to establish a secure session over a network connection including validating data received in said request and following establishment of said session acting on a further request to access an application by providing at least part of said previously validated data to said application for authentication and/or encryption purposes.

In order to aid in understanding the present invention, a particular embodiment thereof will now be described by way of example and with reference to the accompanying drawings.

### BRIEF DESCRIPTION OF THE DRAWINGS

FIG. 1 is a diagrammatic view of a transaction security system according to the present invention;

FIG. 2a is a more detailed view of the system of FIG. 1 with the intermediate infrastructure omitted for clarity

FIG. 2b is a similar view to FIG. 2b with elements of a gateway server omitted for clarity;

FIG. 3 is a signal diagram illustrating a method according to the present invention;

FIG. 4 is a similar view illustrating further steps in the method of FIG. 3;

FIG. 5 is a diagrammatic view of the system of FIG. 1 in accordance with a further aspect of the invention, and

FIG. 6 is a similar view of the system of FIG. 1 in accordance with a still further aspect of the invention.

### DETAILED DESCRIPTION OF THE PREFFERED EMBODIMENTS

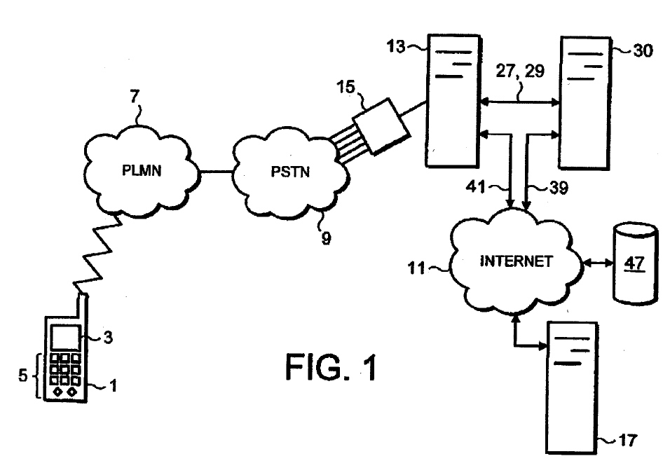

Referring to the Figures and in particular FIG. 1, there is shown terminal 1 having a display 3 and a set of keys 5 including alphanumeric keys. Through these keys 5, a user is able, via a user interface, to operate the terminal 1.

The terminal 1 forms a mobile element of a Public Land Mobile Network (PLMN) 7 the operation of which will be well known to those skilled in the art.

It will noted that the PLMN 7 provides access to external networks including a Public Switched Telephone Network (PSTN) 9.

In addition to conventional telephone operations, the terminal 1 provides its user U with access to the Internet 11 via a gateway server 13. The gateway server 13 may be operated by a service provider or perhaps a particular organization such as a bank which for security reasons wishes to keep control over the gateway server 13. A pool of modems 15 connected to the PSTN 9 provides dial-up access from the terminal side to the gateway server 13.

Other access routes may be employed depending on the capability of the terminal I and PLMN 7.

As part of its service to customers, an organization such as a bank B allows transactions such as money transfers, share dealing and so on to be carried out electronically using a terminal 1 and an Internet 11 connection. Software through which the transactions are carried out is provided by various so-called back-end applications resident on an applications server 17. Again, for security reasons, the applications server is located in premises of the bank B.

In the case of a terminal 1 connected to the PSTN 9, access to a back-end application is provided via the gateway server 13. In this example the gateway server 13 is located on the premises of the bank B although there is nothing to prevent locating the gateway server 13 anywhere there is access to the Internet 11. The gateway server 13 facilitates the exchange of information between the terminal 1 and a remote server connected to the Internet and/or intranet, in this case the bank's own back-end applications server 17.

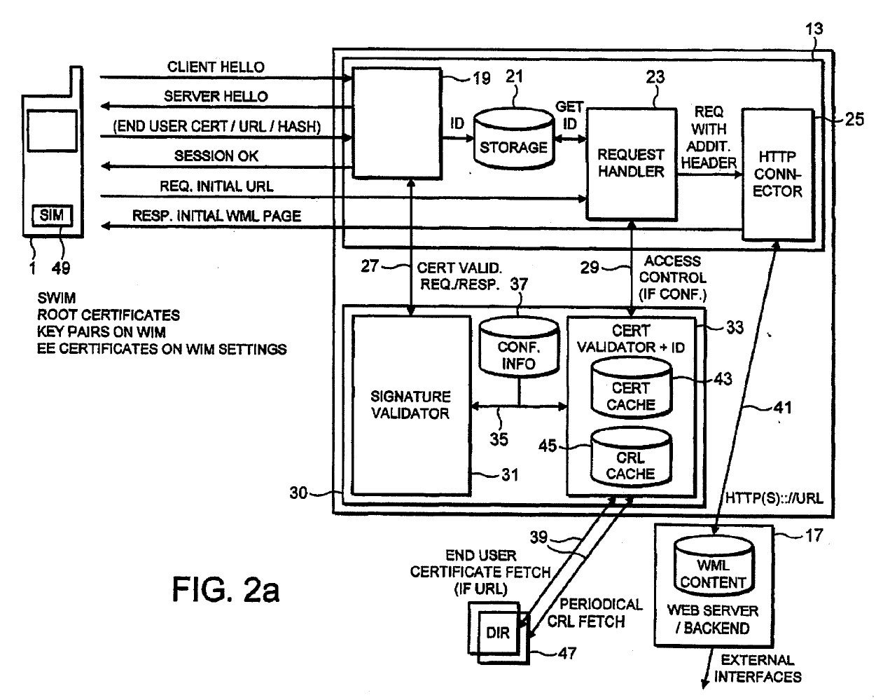

As shown in FIGS. 2a in further detail, the gateway server 13 comprises a number of functional elements. Firstly, a transport layer block 19 with which the terminal 1 initially negotiates access; secondly, a session data store 21; thirdly, a request handler 23 and fourthly an http-connector 25. Furthermore, these elements have a number of external connections. Thus the transport layer block 19 and request handler 23 are connected 27,29 to elements of a trust server 30. These elements include a signature validator 31 and a certificate validator 33. In addition to the external connections 27,29, with the gateway server 13, the trust server 30 has internal connections 35 between the two validators 31,33 and to a configuration store 37 and an external connection 39 between the trust server 30 and the Internet 11. This latter connection 39 permits the trust server 30 to determine the status of information presented to it by the gateway server 13.

Referring again to the gateway server 13, the http-connector 25 is also provided with an external connection 41 to the Internet 11. Through this connection 41 web servers including an application server 17 providing backend applications may be reached.

As will be further elaborated below, the terminal 1 together with the constituent elements of the gateway server 13 each makes use of the wireless Public Key Infrastructure (wPKI). To enhance further the security provided by the gateway 13, the trust server 30 includes a local cache for both certificates and Certificate Revocation Lists (CRL) 43,45. Regular downloads of CRL are made to the cache from a public directory 47 connected to the Internet 11. The CRLs are signed by appropriate Certification Authority (CA).

Before the terminal 1 can be employed by the user in electronic transactions a number of processes are necessary to establish the security necessary to satisfy both the user and the organization, in this case the bank B, with which she is carrying out her transactions.

Consequently, to enable access to the gateway 13 and the backend applications beyond, the terminal 1 is provided with a tamperproof smart card or token 49 which acts as a carrier for data used to substantiate the identity of the terminal user U. During a session, the terminal 1 acts as a conduit for the data stored on the token 49 which is used in securely accessing the relevant back-end application.

The token 49 is manufactured by a card manufacturer which is then delivered to a service provider perhaps the operator of the PLMN, Following delivery, the service provider SP, in this case the operator of the PLMN 7, commences personalization of the token 49 by generating and then storing two unique private/public key pairs on the token 49. Thus there is are provided two private keys and their corresponding public keys, providing respectively, an authentication key and a non-repudiation key. In addition, the service provider root certificate, and URLs pointing to the service provider's SP certificates of the public keys are stored on the token 49. The URLs are formed using an identifier of the token 49 as key data. At this stage however, no certificates yet exist. Thus, the URLs on the card are void and therefore unusable.

The user U completes personalization during acquisition of the token 49. Thus, the user U personally identifies herself to an authorized employee of the service provider SP using a passport or the like. The employee confirms the completed strong identification of the user with his own digital signature, which is then stored by the service provider. The token 49 is then physically handed over to the user U who may now insert it into her terminal 1 for normal mobile telephony purposes. In the meantime,-the service provider SP associates the identifier of the token 49 with the user's subscription. The service provider SP further requests its own Certification Authority (CA) to create certificates for the two public keys on the user's token. The certificates identify the user U as the subject of the certificates, and refer to the token identifier. The CA generates the certificates, stores them on the private certificate Directory 47 of the service provider SP, and returns an OK response to the service provider SP. The service provider SP prints from its database the authentication objects or PINs for the two private keys on the token 49, and sends them through the post to the user U.

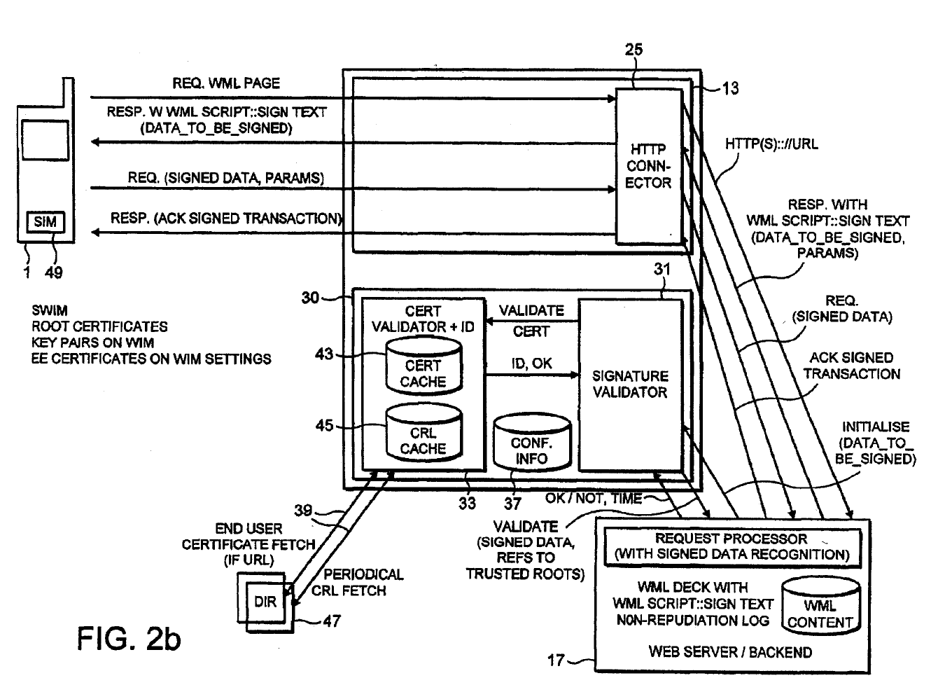

With reference to FIG. 3 and FIG. 2a, the user U is now in a position to be able to register herself as a certified user of the organization, in this case the bank B, with which she wishes to carry out electronic transactions. Thus, the user U firstly initiates a call 101 to the access number of a registration service.

The terminal 1 physically connects to the dedicated gateway server 13 located in the bank's B premises and then attempts to set up a secure session between the terminal 1 and the gateway server 13.

The transport layer block 19 of the gateway server 13 responds 103 by identifying itself with its server certificate and requesting the authentication of the User U. Information identifying the bank B is derived by the terminal 1 from the gateway server certificate and delivered 104 to the user U via the display 3. At the same time, the Terminal 1 requests a response from the user U in the form of an authentication PIN1. Using the keypad 5, the user U enters 105 her PIN1. Providing the correct PIN1 has been entered the terminal 1 then sends 106 a response to the transport layer block 19 containing the URL of the service provider's certificate of the authentication key, the response having been signed using the authentication key stored on user's token 49.

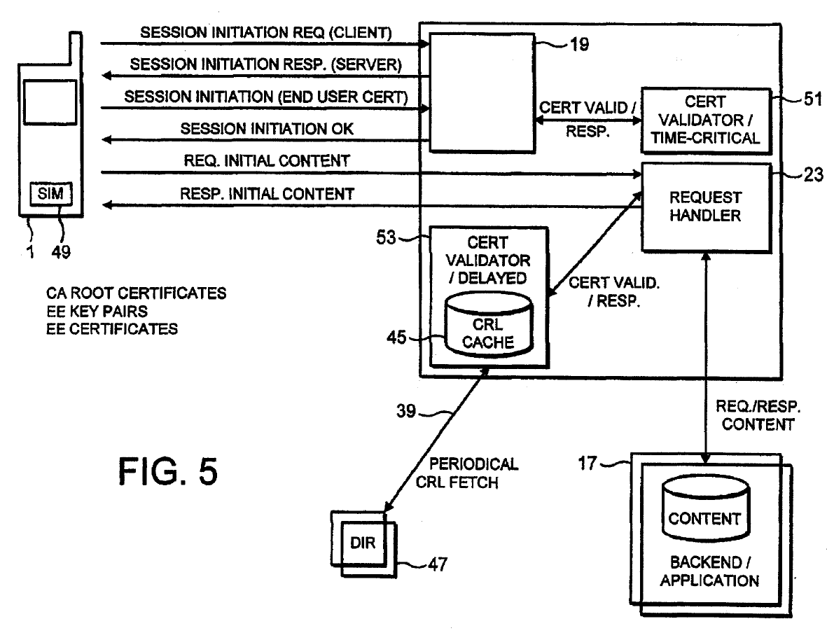

The transport layer block 19 of the Gateway server 13 forwards the authentication response to request handler 23 which passes it to the certificate validator 33 of the Trust Server 30. As shown in more detail in FIG. 5, the certificate validator 33 comprises time critical 51 and non-time critical 53 elements, the first of which, namely the time critical element 51 is activated on receipt of the forwarded authentication response. Hence, the validator 33 identifies the URL containing the service provider's certificate and contacts 108 a corresponding Directory 47 to check the validity of the service provider's certificate for the user U. The Directory 47 responds 109 to the Trust Server 30 with information about the certificate and its status such as its validity period. The outcome of the check is reported 110 to the transport layer block 19 of the trust server. If the status of the certificate is OK, a “session secured” message is sent 111 to the terminal 1 and a secure session is initiated 113, furthermore, the contents of the certificate are stored for the duration of the session in the secure session data store 21. However, before the terminal 1 informs 112 the user U via the display 3 that a secure session is now active between the terminal 1 and the gateway server 13, the certificate validator 33 carries out the non-time critical element 53 and accesses the CRL cache 45 in an attempt to determine the revocation status of the certificate. If no certificate is present in the cache 45, a CRL fetch for the information from the CRL directory 47 is initiated. In either case, the revocation status of the certificate is obtained. If the CRL reveals that the certificate has been revoked, a message to this effect is displayed to inform the user U. The message may include details of the revoked certificate.

In the event that the certificate has been revoked, the session is terminated.

However, should the certificate be in force then the terminal 1 can complete negotiation of the session in accordance with the selected protocol. This may include the generation of shared secrets such as would be understood by those skilled in the art. Whereupon, the terminal 1 is able to send 114 a user authentication request to the registration service of the organization, in this case the bank B.

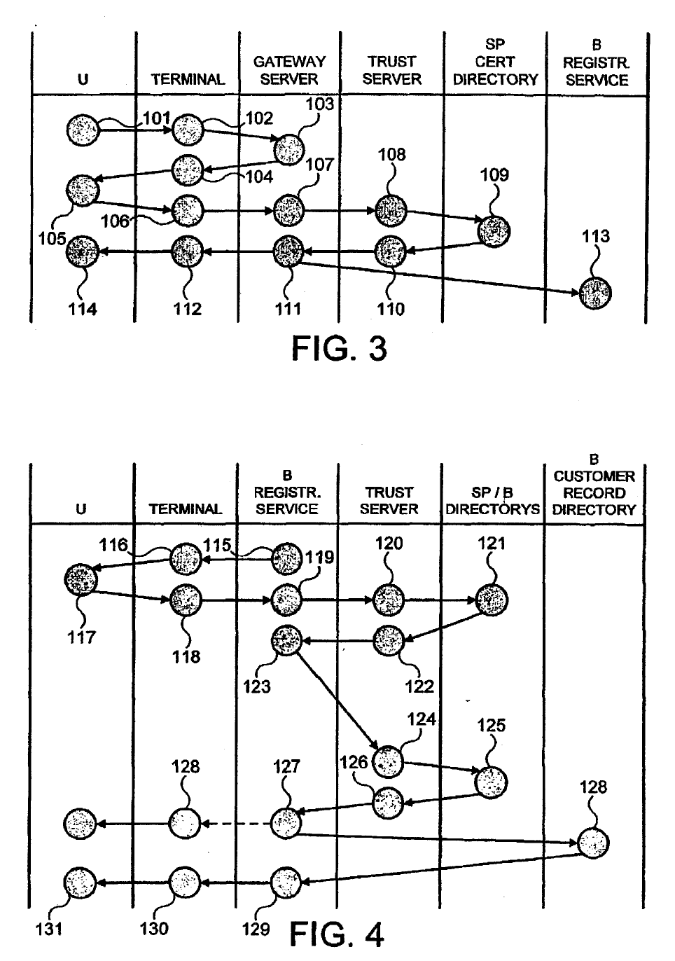

Referring now in particular to FIG. 4, the request is passed by the transport layer block 19 to the request handler 23 which retrieves the contents of the service provider's certificate from the data store 21 and includes them in a header attached to the request. The request, including its header, is then routed by the http-connector 25 via the Internet 11 to the bank registration service which is running on a backend server 17.

The bank registration service recognizes the request as being for registration of a user and extracts the certificate data from the request header. The bank registration service compares the certificate data and in particular the token identity with a customer record directory and seeks to make a match with a previously created record. In the event that no match is found a message to that effect is delivered to the terminal and the session is closed. However, if a match is made the bank registration service responds by sending 115 an acknowledgement text together with a request that the user U enters her nonrepudiation PIN2 at the Terminal 1 to confirm her identity (see FIG. 2b).

The terminal 1 displays 116 the text and the user U duly enters 117 her nonrepudiation PIN2 using the keypad 5 of the terminal 1. Assuming the PIN2 is correctly entered, the terminal 1 uses the private non-repudiation key on the token 49 to sign the response in the manner known to those skilled in the art of asymmetric cryptography. The response is sent 118 via the gateway server 13 (not shown) to the backend server 17 running the bank registration service.

The bank registration service receives the response and forwards 119 it to the Trust Server 30 for the authentication of the signature by the signature validator 31. The signature validator checks the signature in the received message using the public certificate of the non-repudiation key in the manner well known to those skilled in the art of asymmetric cryptography. Thus, the trust server obtains the certificate by requesting 120 it from the Directory 47 containing the non-repudiation public key. The Directory 47 provides 121 the trust server 30 with the certificate details and the trust server 30 returns 122 the results of its analysis of the signature to the bank registration service.

If the status of the certificate was OK and the signature itself was OK, the bank registration service requests 123 that the Trust Server 30 checks whether there already exist Bank certificates for the user's token 49. The Trust Server 30 interrogates 124 the Bank's certificate Directory 47 to determine whether there are certificates associated with the token 49. The token identifier contained in the header with the original registration request from the terminal 1 is thus used as the search term in this query. The directory 47 returns 125 its data to the trust server 30. If, as a result of this check by the trust server 30, the trust server 30 informs 126 the bank registration service that there were already certificates associated with the user's token 49 in the Bank's certificate Directory 47, the terminal is informed 127 and a corresponding message is displayed 128 by the terminal 1 and the user U is informed that the registration has already been done and the registration session is closed. Otherwise, the bank registration service requests an update 128 of the Customer record directory with the information that a token 49 holding the certificates of the Bank is a valid authentication method for the user U.

Subsequently, the bank registration service causes an “authentication successful” message to be delivered to the terminal 1. The user is then able to read 131 a message generated 130 on the display 5 informing the user that registration was successful and that it will be completed after the Bank's certificates have been sent to the user's terminal 1.

Delivery of the certificates may take place by any suitable method including over the air using a SMS route, by a push session either originated by the bank registration service or indeed whilst the registration session is still active.

The user U is now in a position to be able to access the transactional facilities made available to her by the bank B, but using the bank's certificates to establish a secure session over the gateway server 13 to the backend transaction application of the bank B. In some cases such as simple balance enquires and the like it maybe sufficient only for the transactional application to be satisfied that the session has been established using a valid bank certificate in accordance with the process described above in relation to the service provider certificate including a check to determine whether the bank certificate has not been revoked. However, where a more sensitive transaction is being carried out, such as the transfer of money between accounts or making a trade, then the transaction application may, as a further security step, request that a transaction acknowledgement be signed by the User U using her non-repudiation PIN2 to cause the terminal 1 to sign the acknowledgement using the non-repudiation key which may then be checked by the trust server 1 as previously described above including checking the CRL to determine the revocation status of the certificate relating to the nonrepudiation key.

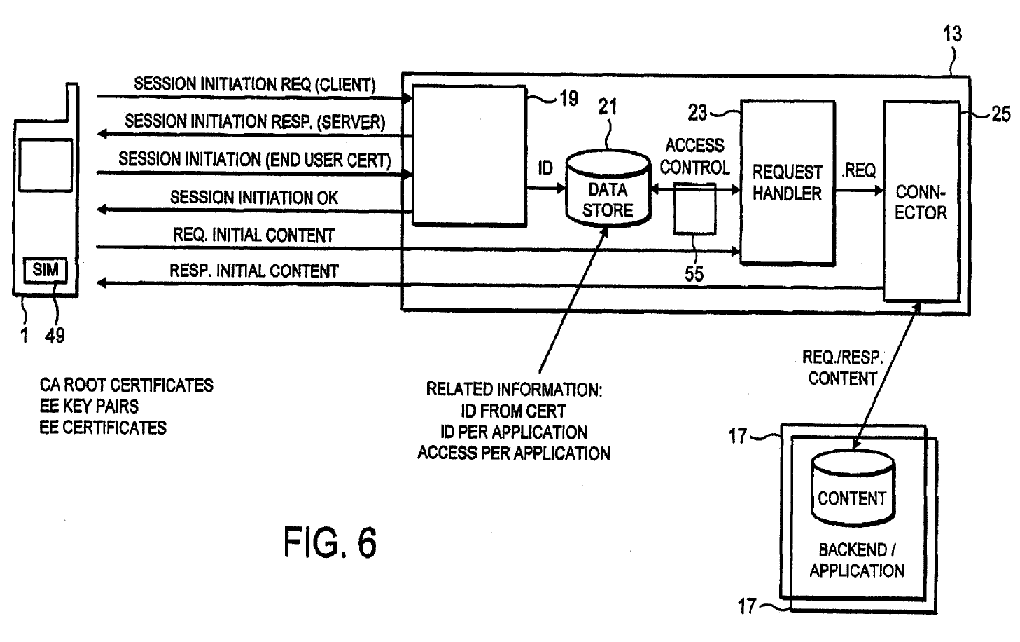

It may well be the case that a gateway server 13 is required to provide access to a plurality of applications operated by different organizations (FIG. 6).

The owner of the gateway server 13 could be an organization such as a bank which could provide the facility to other organizations reluctant or enable to invest in establishing their own gateway. As such, the server 13 is required to provide access not only to applications corresponding to those already described but also to so-called legacy applications. Such a legacy application may be incapable of extracting certificate information from the header of a request passed to it by the http-connector module 25.

Hence, the gateway server 13 further includes an access control module 55 which interprets the received request from a terminal 1 and queries the session data store 21 which may also hold details of access rights and the like for the applications accessible from the gateway 13. Preferably however, the access rights are stored permanently outside of the session data store 21.

This information may be pre-stored, or could be created dynamically following a failure to communicate certificate information to an application in the manner previously described.

Thus, following the authentication of a user as described previously, the ensuing request from the terminal 1 is interpreted by the access control module 55 which establishes firstly whether authorization of the user is required as would be the case for the abovementioned legacy applications. If not, the access control module then passes to the next stage of identifying the access rights including the URLs necessary to access the application on the back-end server 17. As previously described, the request handler then places the certificate information together with any information intended to be included from the data store in a header to the request. The subsequent processing of the request then follows the steps previously described including the CRL check and the optional non-repudiation step.

Alternatively, if the application is identified by the access control 55 as a legacy application, then the access module 55 optionally initiates an authorization step. Whether such a step is required is determined by the access control module 55 which has access to the data store 21 and the particular records for that application. For example, the records may include, in the form of a profile, how the owner of an application wishes particular requests to be handled. In order to authorize the user; a request is sent to the terminal 1 which displays a message asking the user to enter her nonrepudiation PIN2. Once the PIN2 has been correctly entered, the terminal 1 signs the response using the non-repudiation private key and sends the response to the gateway server 13 where it is intercepted by the access control module 55. The access control module 55 asks the request handler 23 to contact the trust server 30 whose signature validator 31 validates the signature against the relevant certificate. Assuming the signature is validated then the access control module 55 allows the original request from the terminal to be passed to the http-connector 25 and thus to the back-end server 17′ on which the legacy application is resident, but not before the certificate has been checked against the CRL cache as described above.

It will be appreciated by those skilled in the art that no reference has been made to a particular protocol for use in establishing a secure session between a terminal and a gateway server. One example of such a protocol is the Wireless Transport Layer Security Specification (WTLS) dated Feb. 18, 2000, which specification forms part of the Wireless Application Protocol published by the Wireless Application Protocol Forum. Similarly an example of one particular embodiment of a token is that set out in another specification published by the Wireless Application Protocol Forum, namely the Wireless application protocol Identity Module (WIM) dated Nov. 5, 1999. The cryptographic tools necessary to provide the functionality set out in the above description are well known to those skilled in the art of asymmetric cryptography, nevertheless, the particular tools required to provide such functionality in the case of the WAP protocol may be further studied in the specification published by the Wireless Application Protocol Forum, namely the WMLScript Crypto Library dated Nov. 5, 1999. Furthermore, the skilled addressee will recognize that the initial registration process outlined in the embodiment is but one of many available. One such alternative process might be to utilize self-signed certificates rather than have them issued by a service provider.

What is claimed is:

1. A trust server connectable to a gateway server controlling access to a remote server, the trust server comprising a validator operable to validate data received from said gateway server and to store said data in data storage such that said data is retrievable by said gateway server, wherein the validator is operable to identify time-critical and non time-critical validations of said data and to deliver status information relating to each said validation to said gateway appropriately.

2. A trust server as claimed in claim 1, wherein the remote server provides access to one or more applications.

3. A trust server as claimed in claim 1, wherein the data is received from a terminal.

4. A trust server as claimed in claim 3, wherein the terminal is a mobile station.

5. A trust server as claimed in claim 1, wherein the data is received from an application.

6. A trust server as claimed in claim 1, wherein the data comprises a public key certificate.

7. A trust server as claimed in claim 1 wherein the data is received from a terminal, the data comprises a public key certificate and the private key corresponding to said public key certificate is stored on said terminal.

8. A trust server as claimed in claim 7, wherein the private key is stored within a token.

9. A trust server as claimed in claim 1, wherein said time critical and non time-critical validations are performed, prior and subsequent to establishment of said session, respectively.

10. A transaction security device for connection to a network including at least one terminal, the device comprising a server operable to validate data provided by a terminal over said connection in order to establish a secure session, wherein said server is operable to carry out time critical and non time-critical validations of said data and to deliver status information relating to each said validation to said device appropriately.

11. A device as claimed in claim 10, including storage for said data.

12. A device as claimed in claim 11, wherein the device is operable to respond to a request from said terminal to access an application by obtaining said previously validated data from said server.

13. A device as claimed in claim 10 , wherein the data comprises a public key certificate.

14. A device as claimed in claim 13, wherein the private key corresponding to said public key certificate is stored on said terminal.

15. A device as claimed in claim 14, wherein the private key is stored within a token.

16. A device as claimed in claim 10, wherein the terminal is a mobile station.

17. A device as claimed in claim 10, wherein said time critical and non time-critical validations are performed, prior and subsequent to establishment of said session, respectively.

18. A transaction security system comprising a gateway server connected to a network including at least one terminal and a trust server connected to said gateway server, the trust server being operable to validate data received from said gateway server as provided by a terminal over said connection in order to establish a secure session between said terminal and gateway server, wherein the validator is operable to carry out time-critical and non time-critical validations of said data and to deliver status information relating to each said validation to said gateway server appropriately.

19. A system as claimed in claim 18, wherein said trust server is responsive to a request from said gateway server to provide said validated data thereto.

20. A system as claimed in claim 18, wherein said trust server is operable to deliver status information relating to said non time-critical validation during said secure session.

21. A system as claimed in claim 18, wherein the data comprises a public key certificate.

22. A system as claimed in claim 21, wherein the private key corresponding to said public key certificate is stored on said terminal.

23. A system as claimed in claim 22, wherein the private key is stored within a token.

24. A system as claimed in claim 18, wherein the terminal is a mobile station.

25. A system as claimed in claim 18, wherein said time critical and non time-critical validations are performed, prior and subsequent to establishment of said session, respectively.

26. A transaction security method for a server connected to a network, the method comprising receiving a request to establish a secure session over a network connection and enabling said secure session in response to successful validation of data accompanying said request and following the establishment of said session, selectively performing a further validation of said data such that said session is terminated following an unsuccessful such further validation.

27. A method as claimed in claim 26, including generating said secure session request in a terminal connected to said network.

28. A method as claimed in claim 26, wherein the data comprises a public key certificate.

29. A method as claimed in claim 27, wherein the data comprises a public key certificate, and a private key corresponding to said public key certificate is stored on said terminal.

30. A method as claimed in claim 29, wherein the private key is stored within a token.

31. A method as claimed in claim 27, wherein the terminal is a mobile station.

32. A computer program comprising executable code for execution when loaded on a computer, wherein the computer is operable in accordance with said code to carry out the method according to claim 26.

33. A program as claimed in claim 32, stored on a computer readable medium.

34. A transaction security device for connection to a network including at least one terminal, the device comprising a server operable to validate data provided by a terminal over said connection in order to establish a secure session and a controller providing access to at least one application over said secure session, the device being operable to respond to a request from said terminal to access an application by obtaining at least part of said previously validated data from said server and forwarding said data to said controller, wherein access to an application is determined by said controller in accordance with said data.

35. A device as claimed in claim 34, wherein said controller is operable to select an application for access by said terminal in accordance with said data.

36. A device as claimed in claim 34, wherein the data comprises a public key certificate.

37. A device as claimed in claim 36, wherein the private key corresponding to said public key certificate is stored on said terminal.

38. A device as claimed in claim 37, wherein the private key is stored within a token.

39. A device as claimed in claim 34, wherein the terminal is a mobile station.

40. A transaction security system comprising a server connected to a network including at least one terminal, the server being operable to validate data provided by a terminal over said connection in order to establish a secure session therewith, said server being further operable to respond to a request from said terminal for access to an application by providing at least part of said validated data to a controller, such that a determination on whether to permit access by said terminal is made by said controller in response to said validated data.

41. A system as claimed in claim 40, wherein said controller is operable to select an application for access by said terminal in accordance with said data.

42. A system as claimed in claim 40, wherein the data comprises a public key certificate.

43. A system as claimed in claim 42, wherein the private key corresponding to said public key certificate is stored on said terminal.

44. A system as claimed in claim 43, wherein the private key is stored within a token.

45. A system as claimed in claim 40, wherein the terminal is a mobile station.

46. A transaction security method for a server connected to a network, the method comprising the server acting on a request to establish a secure session over a network connection by validating data received in said request and, following establishment of said session, determining whether to allow a request to access an application by reference to at least part of said previously validated data.

47. A method as claimed in claim 46, including generating said secure session request in a terminal connected to said network.

48. A method as claimed in claim 46, including generating said application access request in a terminal connected to said network.

49. A method as claimed in claim 46, wherein the data comprises a public key certificate.

50. A method as claimed in claim 48, wherein the data comprises a public key certificate, and a private key corresponding to said public key certificate is stored on said terminal.

51. A method as claimed in claim 50, wherein the private key is stored within a token.

52. A method as claimed in claim 46, wherein the terminal is a mobile station.

53. A computer program comprising executable code for execution when loaded on a computer, wherein the computer is operable in accordance with said code to carry out the method according to claim 46.

54. A program as claimed in claim 53, stored on a computer readable medium.

55. A trust server connectable to a gateway server controlling access to a remote server, the trust server comprising a validator, and data storage, wherein the validator is responsive to a first request from said gateway server to deliver status information relating to data received by said gateway server and to store said data in said storage such that said data is retrievable by said gateway server, said gateway server being operable to determine from said retrieved data and status information whether to allow a request to access said remote server.

56. A trust server as claimed in claim 55, wherein the remote server provides access to one or more applications.

57. A trust server as claimed in claim 55, wherein the data is received from a terminal.

58. A trust server as claimed in claim 57, wherein the terminal is a mobile station.

59. A trust server as claimed in claim 55, wherein the data is received from an application.

60. A trust server as claimed in claim 55, wherein the data comprises a public key certificate.

61. A trust server as claimed in claim 57, wherein the data comprises a public key certificate, and a private key corresponding to said public key certificate is stored on said terminal.

62. A trust server as claimed in claim 61, wherein the private key is stored within a token.

63. A trust server connectable to a gateway server controlling access to a remote server, the trust server comprising a validator and data storage, wherein the validator is responsive to a first request from said gateway server to deliver status information relating to data received by said gateway server and to store said data in said storage such that said data is retrievable by said gateway server for inclusion in a request to said remote server.

64. A trust server as claimed in claim 63, wherein the remote server provides access to one or more applications.

65. A trust server as claimed in claim 63, wherein the data is received from a terminal.

66. A trust server as claimed in claim 65, wherein the terminal is a mobile station.

67. A trust server as claimed in claim 63, wherein the data is received from an application.

68. A trust server as claimed in claim 63, wherein the data comprises a public key certificate.

69. A trust server as claimed in claim 65 and claim 68, wherein the private key corresponding to said public key certificate is stored on said terminal.

70. A trust server as claimed in claim 69, wherein the private key is stored within a token.

71. A transaction security device for connection to a network including at least one terminal, the device comprising a server operable to validate data provided by a terminal over said connection in order to establish a secure session, the device being operable to respond to a request from said terminal to access an application by obtaining said previously validated data from said server and forwarding said data to said application along with said request.

72. A device as claimed in claim 71, wherein the data comprises a public key certificate.

73. A device as claimed in claim 72, wherein the private key corresponding to said public key certificate is stored on said terminal.

74. A device as claimed in claim 73, wherein the private key is stored within a token.

75. A device as claimed in claim 71, wherein the terminal is a mobile station.

76. A transaction security system comprising a server connected to a network including at least one terminal, the server being operable to validate data provided by a terminal over said connection in order to establish a secure session therewith, said server being further operable to respond to a request from said terminal for access to an application by providing said validated data to said application, such that a determination on whether to permit access by said terminal is made by said application in response to said validated data.

77. A system as claimed in claim 76, wherein the data comprises a public key certificate.

78. A system as claimed in claim 77, wherein the private key corresponding to said public key certificate is stored on said terminal.

79. A system as claimed in claim 78, wherein the private key is stored within a token.

80. A system as claimed in claim 76, wherein the terminal is a mobile station.

81. A transaction security method for a server connected to a network, the method comprising acting on a request to establish a secure session over a network connection including validating data received in said request and following establishment of said session acting on a further request to access an application by providing at least part of said previously validated data to said application for authentication and/or encryption purposes.

82. A method as claimed in claim 81, including generating said secure session request in a terminal connected to said network.

83. A method as claimed in claim 81, including generating said application access request in a terminal connected to said network.

84. A method as claimed in claim 81, wherein the data comprises a public key certificate.

85. A method as claimed in claim 82, wherein the data comprises a public key certificate, and a private key corresponding to said public key certificate is stored on said terminal.

86. A method as claimed in claim 85, wherein the private key is stored within a token.

87. A method as claimed in claim 82, wherein the terminal is a mobile station.

88. A computer program comprising executable code for execution when loaded on a computer, wherein the computer is operable in accordance with said code to carry out the method according to claim 81.

89. A program as claimed in claim 88, stored on a computer readable medium.
